(19) United States
(12) Patent Application Publication
(10) Pub. No.: US 2005/0267283 A1
(43) Pub. Date: Dec. 1, 2005

(54) Process for adding nitrogen containing methine light absorbers to poly(ethylene terephthalate)

(76) Inventors: Max Allen Weaver, Kingsport, TN (US); Jason Clay Pearson, Kingsport, TN (US); Perry Michael Murdaugh SR., Lexington, SC (US); Earl Edmondson Howell JR., Kingsport, TN (US)

Correspondence Address: Dennis V. Carmen;Eastman Chemical Company, P.O. Box 511, Kingsport, TN, 37662-5075, US

(21) Appl. No.: 10/855,246

(22) Filed: May 27, 2004

(51) Int. Cl. C08G 63/02

(52) U.S. Cl. 528/272

(57) ABSTRACT

A method for incorporating a nitrogen containing methine light absorbing compound into a polyester prepared using direct esterification of reactants selected from a dicarboxylic acid and a diol, the method comprising reacting the reactants in an esterifying reactor under conditions sufficient to form an esterified product including at least one of an ester, an oligomer, or mixture having an ester and a mixture of low molecular weight polyester; polymerizing the esterified product in a polycondensation reactor to form a polyester; and adding the light absorbing compound to the esterified products when at least 50% of the carboxy groups initially present in the reactants have been esterified. Articles utilizing the light protected polyester are additionally disclosed.

### BACKGROUND OF THE INVENTION

1. Field of the Invention

The present invention relates to method for incorporating a light absorbing compound into a condensation polymer. More particularly, the present method relates to incorporating a nitrogen containing methine light absorbing compound into a polyester composition.

2. Background of the Invention

Polyester is a widely used polymeric resin in a number of packaging and fiber based applications. Commercial polyester production, in general, involves direct esterification, where the desired glycol, in molar excess, is reacted with an aromatic dicarboxylic acid to form an ester; or by transesterification or ester exchange if the starting aromatic moiety is a low molecular weight diester of an aromatic dicarboxylic acid, such as dimethyl terephthalate (DMT) which is polycondensed under reduced pressure and at elevated temperatures form to poly(ethylene terephthalate) (PET). Since the product of these condensation reactions tend to be reversible and in order to increase the molecular weight of the polyesters, this reaction is often carried out in a multi-chamber polycondensation reaction system having several reaction chambers operating in series. In the case where the starting aromatic moiety is an aromatic dicarboxylic acid, water is the by-product of the reaction. In the case where the starting aromatic moiety is a diester of an aromatic dicarboxylic acid, such as DMT, methanol is the by-product of the reaction. In either case, the reaction by-product is removed by distillation.

The diglycol ester then passes to the second, prepolymerization step to form intermediate molecular weight oligomers before passing to the third, melt polyesterification step or polycondensation step operated at low pressure and high temperature. The molecular weight of the polymer chain continues to increase in this second chamber with volatile compounds being continually removed. This process is repeated successively for each reactor, with each successive reactor being operated at lower and lower pressures. The result of this step wise condensation is the formation of polyester with high molecular weight and a higher inherent viscosity relative to the esterification step. For some applications requiring yet higher melt viscosity, solid-state polymerization is practiced.

Poly(ethylene terephthalate) or a modified PET is the polymer of choice for making beverage and food containers such as plastic bottles and jars used for carbonated beverages, water, juices, foods, detergents, cosmetics, and other products. However, many of these products are deleteriously affected, i.e., degraded, by ultraviolet (UV) light at wavelengths in the range of approximately 250 to 390 nanometers (nm). It is well known that polymers can be rendered resistant to light degradation by physically blending in such polymers various light stabilizers such as benzophenones, benzotriazoles and resorcinol monobenzoates. Although these stabilizers function well to absorb radiation, many of these compounds would decompose under the conditions at which polyesters are manufactured or processed. Decomposition of such stabilizers frequently causes yellow discoloration of the polyester and results in the polyester containing little, if any, of the stabilizer.

U.S. Pat. No. 4,617,374 to Pruett et al. discloses the use of certain UV-absorbing methine compounds that may be incorporated into the polyester or a polycarbonate composition. These light absorbing compounds have been found to be useful in the preparation of polyesters such as poly(ethylene terephthalate) and copolymers of poly(ethylene terephthalate) and poly(1,4-cyclohexylenedimethylene terephthalate). The compounds enhance ultraviolet or visible light absorption with a maximum absorbance within the range of from about 320 nm to about 380 nm. Functionally, these compounds contain an acid or ester group which condenses onto the polymer chain as a terminator. Pruett et al. teach preparing the polyester using transesterification and adding the light absorbing compound at the beginning of the process. However, it has been discovered that the process by which the polyester is prepared contributes to the efficiency at which certain light absorbing compounds are incorporated into the polyester. The loss of light absorbing compounds results in added costs for the polyester formation.

Accordingly, there is a need for improved methods of incorporating light absorbing compounds into polyester compositions made utilizing direct esterification method.

### SUMMARY OF THE INVENTION

One aspect of the present invention is a method for incorporating a hydrolysis sensitive light absorbing compound into. a polyester where the polyester is prepared using a direct esterification process. The process includes the steps of directly esterifying reactants comprising a dicarboxylic acid and a diol at reaction conditions sufficient to form esterified products comprising at least one of: an ester, an oligomer, or mixture comprising an ester and a mixture of low molecular weight polyester; subjecting the esterified product to polycondensation to form a polyester; and adding at least one light absorbing compound to the esterified products when at least 50 percent of the carboxy groups initially present in the reactants have been esterified. Desirably, from 0 to 100% of the desired amount of light absorbing compound is added to the esterified product: during one or more polycondensation steps wherein high molecular weight polyester may be prepared by subjecting the esterified products from the esterification reactor to a plurality of polycondensation zones of increasing vacuum and temperature.

Another aspect of the present invention is a polyester prepared utilizing the method of the present invention as well as articles made from the polyester composition.

Accordingly, it is an object of the present invention to provide a method for incorporating the light absorbing compound into a polyester prepared using direct esterification of a diacid and a diol.

Another object of the present invention is a polyester having incorporated therein a light absorbing compound, wherein the polyester is prepared using direct esterification of a diacid and a diol and the light absorbing compound is susceptible to hydrolysis.

It is another object of the present invention is a polyester article wherein the polyester includes a light absorber that is incorporated into the polyester by the method of the present invention.

These and other objects and advantages of the present invention will become more apparent to those skilled in the art in view of the following description. It is to be understood that the inventive concept is not to be considered limited to the constructions disclosed herein but instead by the scope of the appended claims.

### DETAILED DESCRIPTION OF THE INVENTION

The polyesters which may be used in accordance with the present invention include linear, thermoplastic, crystalline or amorphous polyesters produced by direct esterification and polymerization techniques from reactants selected from one or more dicarboxylic acids and one or more diols. As used herein, the term “polyester” is used generally and includes homopolymers and copolymers. For example, a mixture of dicarboxylic acids, preferably aromatic dicarboxylic acids, and one or more diols may be heated in the presence of esterification and/or polyesterification catalysts at temperatures in the range of about 150° to about 300° C. and pressures of atmospheric to about 0.2 mm mercury. Normally, the dicarboxylic acid is esterified with the diol(s) at atmospheric pressure and at a temperature at the lower end of the specified range: The polyesters normally are molding or fiber grade and have an intrinsic viscosity (IV) of about 0.4 to about 1.2 dL/g, as measured in accordance with ASTM method D4603-03, using a solution of 0.25 grams of polymer dissolved in 25 ml of a solvent solution comprised of 60 weight % phenol and 40 weight % 1,1,2,2,-tetrachloroethane.

The preferred polyesters comprise at least about 50 mole percent terephthalic acid residues and at least about 50 mole percent ethylene glycol and/or 1,4-cyclohexanedimethanol residues, wherein the acid component comprises 100 mole % and the diol component comprises 100 mole %. Particularly preferred polyesters are those containing from about 75 to 100 mole percent terephthalic acid residues and from about 75 to 100 mole percent ethylene glycol residues, wherein the acid component has 100 mole % and the diol component has 100 mole %. As used herein, “residue” means the portion of a compound that is incorporated into a polyester composition after polycondensation.

Generally, direct esterification processes are well known to those skilled in the art and include such processes described in U.S. Pat. No. 4,100,142; 3,781,213; and 3,689,481, the entire disclosures of which are incorporated herein by reference.

In one embodiment of the present invention, polyesters of suitable quality may be prepared in a continuous manner by directly esterifying the dicarboxylic acid with the glycol in an esterification reactor operated at a pressure above the partial vapor pressure of the glycol and at a reaction temperature sufficient to allow the continuous removal of water from the esterification reaction, continuing the esterification for a time sufficient to form esterification products and adding the UV absorbing compounds to the esterified products present when at least 50% of the carboxy groups initially present in the dicarboxylic acid reactant is esterified. Accordingly, the UV absorbing compound may added to the esterification reactor(s), the polycondensation reactor(s) or a combination of both esterification and polycondensation reactor(s). Such esterification products are well known to those skilled in the art and include at least one of: an ester, an oligomer, a low molecular weight polyester and mixtures thereof. An important aspect of the present invention is that at least 50% of the carboxy groups initially present in the reactants be esterified before the light absorbing compound(s) is/are added to the esterification products present in the esterification reactor. Desirably, at least about 70%, preferably at least about 80%, more preferably at least about 85% and most preferably greater than about 90% of the carboxy groups initially present in the reactants are esterified before the light absorbing compounds are added to the esterified products.

The amount of light absorbing compound that may be added to the esterification reactor can range from 0 to 100% of the desired amount to be incorporated into the polyester. Preferably, the amount of light absorbing compound added to the esterification reactor is from 0 to about 80% with the remaining amount added to the esterified products in the polycondensation reactor. More preferably, the amount of light absorbing compound added to the esterification reactor is from 0 to about 50% of light absorbing compound with the remaining amount added to the esterified products in the polycondensation reactor. It is understand that the amounts or quantitative ranges used herein includes not only those amounts expressly specified, but would also includes all intermediate ranges therein. One skilled in the art will recognize that the amount of light absorbing compound added to the reactor and the desired amount to be incorporated into the polyester may be different and depends upon the yield of the light absorbing compound incorporated into the polyester.

The amount of light absorbing compound that may be added to the esterification reaction process and have a yield greater than 40% is directly proportional to the percentage of esterified carboxy groups initially present in the reactants. That is, as the amount of esterified products present in the esterification reaction process increases, an increasing amount of light absorbing compounds can be added to the esterification reactor(s) without deleterious effects to the light absorbing compounds. However, it is important to the present invention that at least 50% of the carboxy groups initially present in the reactants be esterified before any amount of light absorbing compounds are added to the esterification reactor.

Following esterification, high molecular weight polyester may be prepared using any known polycondensation process wherein the esterification products prepared in the esterification reactor are passed through a plurality of zones of increasing vacuum and temperature terminating, for example, with a polymer finisher operating under a vacuum of about 0.1 to 10 mm Hg at a temperature of about 270° to 31 0C. One skilled in the art will understand that such zones may be incorporated into a single reactor having a plurality of distinct operational zones, each of which have a distinct operating temperature, pressure and residence time or such zones may be represented by a plurality of distinct polycondensation reactors operated in series such that the polyester mixture is progressively polymerized in the melt phase where the polyester removed from the last reaction chamber has an inherent viscosity of from about 0.1 to about 0.75 dL/g, measured in accordance with the method described above.

In accordance with the present invention, from 0 to 100% of the desired amount of light absorbing compound to be incorporated into the polyester may be added to the polycondensation reactor during any stage of polycondensation. Preferably, the amount of light absorbing compound that may be added to the polycondensation reactor during polycondensation is greater than 50%, more preferably greater than 80%, and most preferably greater than 95%. Although not to be bound to any theory, it is believed that the water evolved during esterification reduces the yield of light absorbing compound incorporated into the polyester. Thus, the light absorbing compound may be added to the esterification reactor(s) when at least 50 percent of the carboxy groups initially present in the reactants have been esterified, or desirably may be added to the polycondensation reactor(s) at any stage during polycondensation since the material in the polycondensation reactor generally has greater than 90 percent of the carboxy groups esterified. Alternatively, a portion of the UV absorbing compound can be added to the esterified products in the esterification reactor(s) and the balance of the UV absorbing compound is added to the PET in the polycondensation reactor(s).

Adding the light absorbing compound in accordance with the present invention provides a yield of light absorbing compound incorporated into the polyester of greater than 40%, preferably greater than 60%, more preferably greater than 70%, and most preferably greater than 85%. As used herein, “yield” is the percent value of the amount of light absorbing compound residue(s) present in the polyester divided by the amount of light absorbing compound(s) added to the process per unit of polymer.

The concentration of the light absorbing compound, or its residue, in the condensation polymer can be varied substantially depending on the intended function of the light absorbing residue and/or the end use of the polymer composition. For example, when the polymer composition is for fabricating relatively thin-walled containers, the concentration of the light absorbing compound will typically be in the range of from about 50 to 1500 ppm (measured in parts by weight light absorber per million parts by weight polymer) with the range of about 200 to 800 ppm being preferred. Concentrations of light absorbers may be increased to levels of from about 0.01 to about 5.0% if it is desired for the polymers containing these light absorbing compounds to have improved resistance to weathering and/or when the polymers or fibers made therefrom are dyed with disperse dyes. Polymer compositions containing substantially higher amounts of the light absorbing compound, or its residues, e.g., from about 2.0 to 10.0 weight percent, may be used as polymer concentrates. Such concentrates may be blended with the same or different polymer according to conventional procedures to obtain polymer compositions which will contain a predetermined amount of the residue or residues in a non-extractable form.

The polyesters that are suitable for incorporating the light absorbers in accordance with the method of the present invention are polyesters formed by the direct reaction of a dicarboxylic acid with a diol. The diacid component can be selected from aliphatic, alicyclic, or aromatic dicarboxylic acids. Suitable diacid components may be selected from terephthalic acid; naphthalene dicarboxylic acid; isophthalic acid; 1,4-cyclohexanedicarboxylic acid; 1,3-cyclohexanedicarboxylic acid; succinic acid; glutaric acid; adipic acid; sebacic acid; and 1,12-dodecanedioic acid. Preferably, the diacid component is terephthalic acid.

The diol component of the polyester may be selected from ethylene glycol; 1,4-cyclohexanedimethanol; 1,2-propanediol; 1,3-propanediol; 1,4-butanediol; 2,2-dimethyl-1,3-propanediol; 1,6-hexanediol; 1,2-cyclohexanediol; 1,4-cyclohexanediol; 1,2-cyclohexanedimethanol; 1,3-cyclohexanedimethanol; 2,2,4,4-tetramethyl-1,3-cyclobutane diol; X,8-bis(hydroxymethyl)tricyclo-[5.2.1.0]-decane wherein X represents 3, 4, or 5; diols containing one or more oxygen atoms in the chain, e.g., diethylene glycol, triethylene glycol, dipropylene glycol, tripropylene glycol; diols containing from about 2 to about 18, preferably 2 to 12 carbon atoms in each aliphatic moiety and mixtures thereof. Cycloaliphatic diols can be employed in their cis or trans configuration or as mixtures of both forms. More preferably, the diol includes ethylene glycol; diethylene glycol; 1,4-cyclohexanedimethanol; and mixtures thereof. In many cases, the diol may comprise a major amount of ethylene glycol and modifying amounts cyclohexanedimethanol and/or diethylene glycol.

The terephthalic acid and ethylene glycol may be fed separately into the esterification reactor. However, an economic benefit is realized by the employment of a single feed line supplying terephthalic acid and ethylene glycol to the esterification reactor. The duplication of feed system and pressure regulation problems with separate glycol and acid feed lines are eliminated with the employment of a single reactant feed system. It has been found that for substantially complete esterification of the dicarboxylic acid component in the reaction mixture, i.e., greater than 90%, an excess quantity of diol over the stoichiometric quantity is required. A diol/diacid ratio in the range of about 1.01:1 to 2.5:1, respectively, is desirable. Certainly, a greater excess of glycol would be operable, but would be uneconomical. With the employment of the self-compensating primary esterification unit, coupled with the fact that esterification and low molecular weight oligomer formation proceed nearly simultaneously, a relatively low molar ratio of diol/diacid of the order of 1.1:1 to 1.8: 1, respectively is preferred. Optionally, a paste or slurry may be prepared from terephthalic acid/ethylene glycol in the molar ratio of about 1.2:1 to 1.4:1, respectively, and preferably about 1.3:1, respectively, to be pumped under an applied pressure to the esterification reactor.

The light absorbing compound can be added to the esterification reactor and/or polycondensation reactor using known methods for the addition of such additives. For example, the light absorbing compound may be added directly to the reactors via a separate feed line or may be mixed with any type of fluid that is compatible with a polyester process. The light absorbing compound can be a dilute solution or a concentrated dispersion or slurry that is capable of being pumped directly into the reactor or may be added to a carrier stream, such as one or more of the reactant or recycle streams. As one skilled in the art will understand, the singular term “reactor” can include a single reactor or a plurality of reactors, with each reactor having one or more reaction zones. Moreover, the term “reactor” can further include feed points that are physically located outside of the reactor, such as, for example, at a pump inlet or discharge, a recirculation line, a reflux point, as well as one or more points in associated piping and transfer equipment. For example, a side stream of products may be removed from the PET esterification process, the polycondensation process, or both, wherein the light absorbing compound is admixed with the contents of the side stream, which is then returned to the reactor. However, the term “reactor” is used herein for the sake of brevity and clarity of description.

Light absorbing compounds suitable for use in the present invention are described in greater detail in U.S. Pat. Nos. 4,981,516; 5,030,708; 5,401,438; 4,661,566; 4,617,373; 5,106,942; 5,274,072; 5,456,725; 6,207,740; and 6,559,216, the entire disclosures of which are incorporated herein by reference. More specifically, the light absorbing compounds which are useful in the practice of this invention typically have at least one methine moiety defined herein as “the group 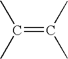
conjoined with a conjugated aromatic or heteroaromatic system”. This moiety imparts the property of ultraviolet and/or visible light absorption, generally within the range of about 350-650 nanometers (nm). More preferably, the compounds absorb light within the range of about 350 to 550 nm. The methine compounds usually have molecular weight of from about 200 to about 600 Daltons, although lesser and higher molecular weights are useful. The light absorbing compounds are further characterized by having at least one polyester reactive group which will react with at least one of the functional groups from which the polyester is prepared into the polymer chain during polyester preparation. Such polyester reactive groups are selected from hydroxyl, carboxy, amino, C₁-C₆-alkoxycarbonyl, C₁-C₆-alkoxycarbonyloxy and C₁-C₆-alkanoyloxy. These light-absorbing compounds are thermally stable at polymer processing temperatures up to about 300° C.

Preferred methine UV-visible light absorbing compounds or monomers useful in the practice of the present invention have the general formulae: 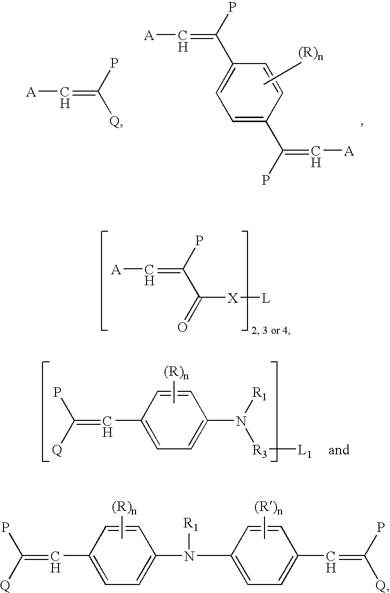
wherein:

A is conjugated with the attached double bond and is selected from the group of nitrogen containing moieties having the following formulae:

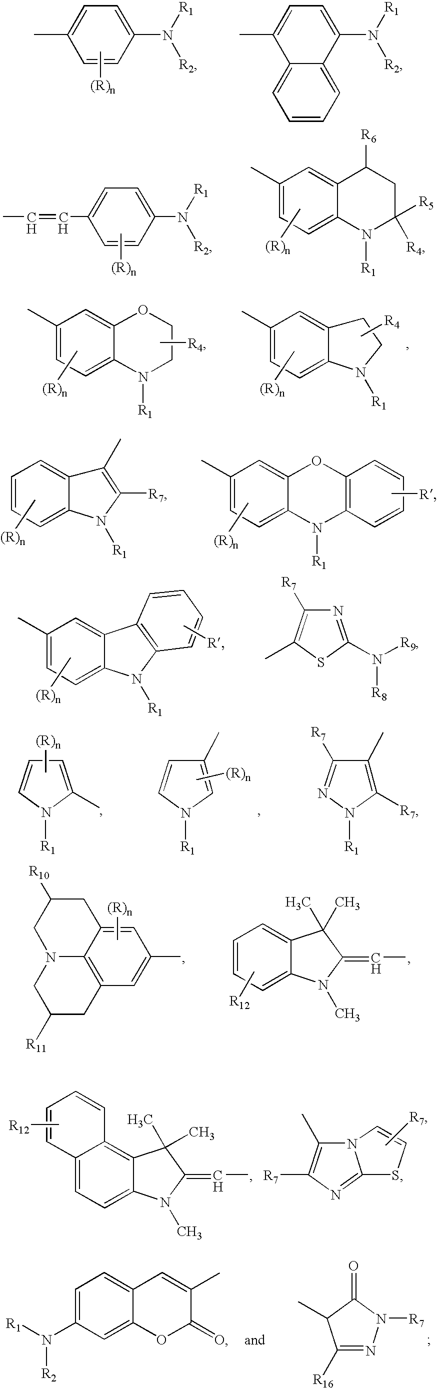

R and R′ are independently selected from hydrogen, C₁-C₆ -alkyl, C₁-C₆-alkoxy and halogen;

n is 1 or 2;

R₁ is selected from C₃-C₈-cycloalkyl, C₃-C₈-alkenyl, aryl, C₁-C₁₂-alkyl, substituted C₁-C₁₂-alkyl, and —(CHR₁₃ CHR₁₄O)ₘ—R₁₅, wherein: m is an integer from 1 to about 500, preferably from 1 to about 100, more preferably from 1 to 8, and most preferably from 1 to 3; and

R₂ is selected from C₃-C₈-cycloalkyl, C₃-C₈-alkenyl, aryl, C₁-C₁₂-alkyl, substituted C₁-C₁₂-alkyl, —(CHR₁₃CHR₁₄O)ₘ—R₁₅, and acyl group selected from —COR₁₆, —CO₂R₁₆, —CONHR₁₆— and —SO₂R₁₆, with the provision that when R₂ is an acyl group R₁ may be hydrogen; or

R₁ and R₂ can be combined with the nitrogen atom to which they are attached to make cyclic structures selected from pyrrolidino, piperidino, piperazino, morpholino, thiomorpholino, thiomorpholino-S,S-dioxide, succinimido, and phthalimido;

R₃ is selected from C₁-C₆-alkylene, and —(CHR₁₃CHR₁₄O)ₘ—CHR₁₃CHR₁₄—;

R₄, R₅ and R₆ are independently selected from hydrogen and C₁-C₆-alkyl;

R₇ is selected from hydrogen, C₁-C₆-alkyl and aryl;

R₈ and R₉ are independently selected from C₁-C₁₂-alkyl, substituted C₁-C₁₂-alkyl, aryl, C₃-C₈-cycloalkyl, and C₃-C₈-alkenyl or R₈ and R₉ can be combined with the nitrogen atom to which they are attached to produce cyclic structures such as pyrrolidino, piperidino and morpholino;

R₁₀ and R₁₁, are independently selected from hydrogen, halogen, C₁-C₆-akyl, hydroxyl and C₁-C₆-alkanoyloxy;

R₁₂ is carboxy, C₁-C₆-alkoxycarbonyl or (R)ₘ;

R₁₃ and R₁₄ are independently selected from hydrogen and C₁-C₆-alkyl;

R₁₅ is selected from hydrogen, aryl, C₁-C₁₂-alkyl, and C₁-C₆-alkanoyloxy;

R₁₆ is selected from C₁-C₆-alkyl, C₃-C₈-alkenyl, aryl, and C₃-C₈-cycloalkyl;

X is selected from —O—, —NH and —N(R₁₆)—;

L is a di, tri or tetravalent linking group;

L₁ is selected from a direct single bond or a divalent linking group;

P and Q are independently selected from cyano, —COR₁₆, —CO₂R₁₆, —CON(R₁₇)R₁₈, aryl, heteroaryl, and —SO₂R₁₆; or

P and Q can be combined with the conjugated double-bonded carbon atom to which they are attached to produce the following cyclic divalent radicals:

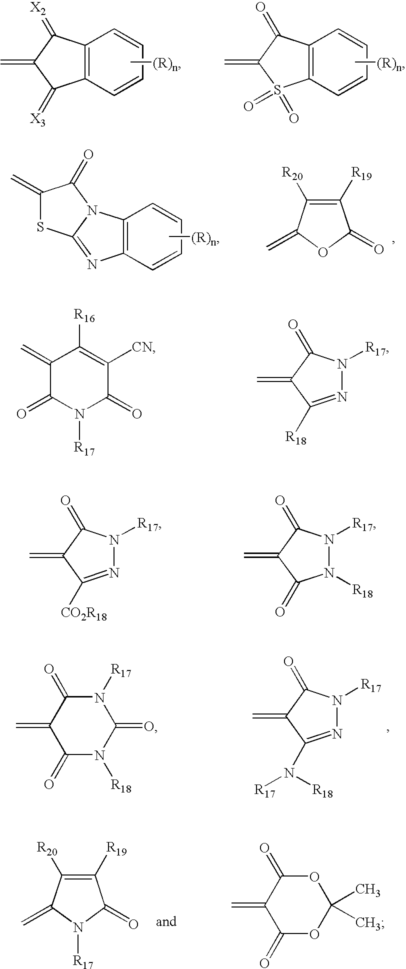

R₁₇ and R₁₈ are independently selected from hydrogen, C₁-C₆-alkyl, aryl C₃-C₈-cycloalkyl, and C₃-C₈-alkenyl;

R₁₉ is selected from cyano, carboxy, —CO₂R₁₆, —CON(R₁₇)R₁₈ and

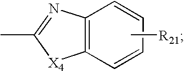

R₂₀ is selected from aryl and heteroaryl;

X₂ and X₃ are independently selected from oxygen and ═C(CN)CN;

X₄ is selected from —O—, —S—, —N(R₁₇)—;

R₂₁ is selected from hydrogen, or up to two groups selected from C₁-C₆-alkyl, C₁-C₆-alkoxy, halogen, carboxy, cyano and —CO₂R₁₆; with the provision that Q may be hydrogen when P is selected from -carboxy, —CO₂R₁₆, —C(R₂₀)═C(CN)CN and

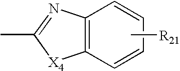

Some of the methine compounds described herein without polyester reactive groups may give increased color yields when utilized under the conditions described in this invention. However, it is preferred that the methine compounds useful in the present invention have at least one reactive group selected from carboxy, —CO₂R₁₆, —OCOR₁₆, —OCON(R₁₇)R₁₈, —OCO₂R₁₆, hydroxyl and chlorocarbonyl, that is capable of reacting into the polyester composition during preparation.

The term “C₁-C₁₂-alkyl” is used herein to denote an aliphatic hydrocarbon radical that contains one to twelve carbon atoms and is either a straight or branched chain.

The term “substituted C₁-C₁₂-alkyl” is used herein to denote a C₁-C₁₂-alkyl radical substituted with 1-3 groups selected from halogen, hydroxyl, cyano, carboxy, succinimido, phthalimido, 2-pyrrolidino, C₃-C₈-cycloalkyl, aryl, heteroaryl, vinylsulfonyl, phthalimidino, o-benzoic sulfimido, —OR₂₂, —SR₂₃, —SO₂R₂₄, —SO₂CH₂CH₂SR₂₃, —CON(R₂₅)R₂₆, —SO₂N(R₂₅)R₂₆, —O₂CN(R₂₅)R₂₆, —OCOR₂₄, —O₂CR₂₄, —OCO₂R₂₄, —OCR₂₄, —N(R₂₅)SO₂R₂₄, —N(R₂₅)COR₂₄, 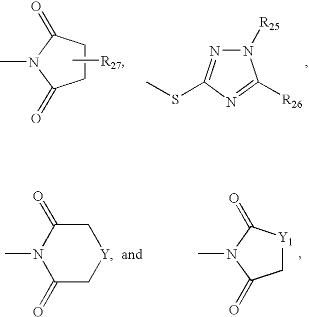
wherein:

R₂₂ is selected from C₁-C₆-alkyl, C₃-C₈-cycloalkyl; C₃-C₈-alkenyl and aryl;

R₂₃ is selected from C₁-C₆-alkyl, C₃-C₈-cycloalkyl, aryl and heteroaryl;

R₂₄ is selected from C₁-C₆-alkyl, C₃-C₈-cycloalkyl and aryl;

R₂₅ and R₂₆ are independently selected from hydrogen, C₁-C₆-alkyl, C₃-C₈-cycloalkyl and aryl;

R₂₇ is selected from hydroxy and C₁-C₆-alkanoyloxy;

Y is selected from —O—, —S—, and —N(R₂₄)—;

Y₁ is selected from C₂-C₄-alkylene, —O—, —S—, and —N(R₂₅)—.

The term “C₁-C₆-alkyl” is used to denote straight and branched chain hydrocarbon radicals, which may optionally be substituted with up to two groups selected from hydroxyl, halogen, carboxy, cyano, aryl, arylthio, arylsulfonyl, C₁-C₆-alkoxy, C₁-C₆-alkylthio, C₁-C₆-alkylsulfonyl, C₁-C₆-alkoxycarbonyl, C₁-C₆-alkoxycarbonyloxy, and C₁-C₆-alkanoyloxy.

The terms “C₁-C₆-alkoxy”, “C₁-C₆-alkylthio”, “C₁-C₆-alkylsulfonyl”, “C₁-C₆-alkoxycarbonyl”, “C₁-C₆-alkoxycarbonyloxy” and “C₁-C₆-alkanoyloxy” denote the following structures, respectively: —OC₁-C₆-alkyl, —S—C₁-C₆-alkyl, —O₂S—C₁-C₆-alkyl, —CO₂-C₁-C₆-alkyl, —O₂C—O—C₁-C₆-alkyl, and —O₂C—C₁-C₆-alkyl, wherein the C₁-C₆-alkyl groups may optionally be substituted with up to two groups selected from hydroxy, cyano, halogen, aryl, —OC₁-C₄-alkyl, —OCOC₁-C₄-alkyl and CO₂C₁-C₄-alkyl, wherein the C₁-C₄-alkyl portion of the group represents saturated straight or branched chain hydrocarbon radicals that contain one to four carbon atoms.

The terms “C₃-C₈-cycloalkyl” and “C₃-C₈-alkenyl” are used to denote saturated cycloaliphatic radicals and straight or branched chain hydrocarbon radicals containing at least one carbon-carbon double bond, respectively, with each radical containing 3-8 carbon atoms.

The divalent linking groups for L can be selected from C₁-C₁₂-alkylene, —(CHR₁₃CHR₁₄O)ₘCHR₁₃CHR₁₄—, C₃-C₈-cycloalkylene, —CH₂-C₃-C₈-cycloalkylene—CH₂— and C₃-C₈-alkenylene. The C₁-C₁₂ alkylene linking groups may contain within their main chain heteroatoms, e.g. oxygen, sulfur and nitrogen and substituted nitrogen, (—N(R₁₇)—), wherein R₁₇ is as previously defined, and/or cyclic groups such as C₃-C₈-cycloalkylene, arylene, divalent heteroaromatic groups or ester groups such as:

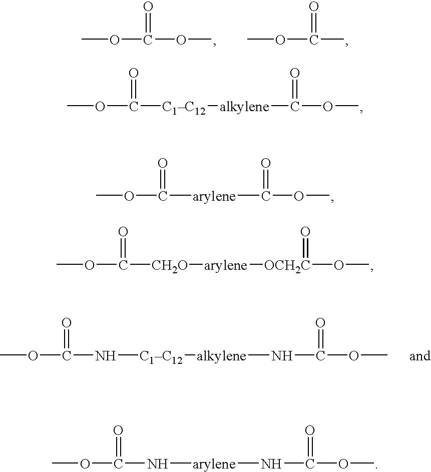

Some of the cyclic moieties which may be incorporated into the C₁-C₁₂-alkylene chain of atoms include:

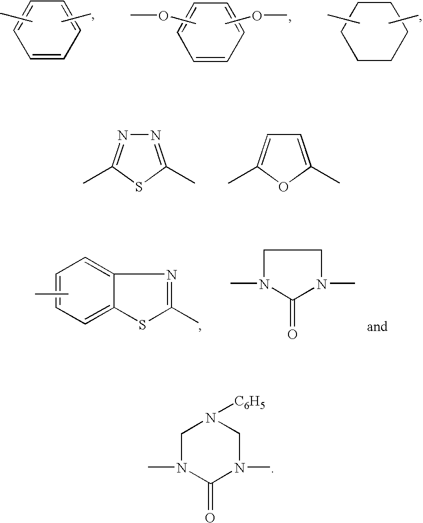

The trivalent and tetravalent radicals for L are selected from C₃-C₈-aliphatic hydrocarbon moieties which contain three or four covalent bonds. Examples of trivalent and tetravalent radicals include —HC(CH₂—)₂ and C(CH₂—)₄, respectively.

The divalent linking groups for L₁ may be selected from —O—, —S—, —SO₂—, ═N—SO₂R₁, —S—S—, —CO₂—, —OCO₂—, arylene, —O-arylene-O—, C₃-C₈-cycloalkylene, —O₂C—C₁-C₁₂-alkylene-CO₂—, —O₂C-arylene-CO₂—, —O₂C—C₃C₈-cycloalkylene-CO₂—, —O₂CNH—C₁-C₁₂-alkylene-NHCO₂—, and —O₂CNH-arylene-NHCO₂—.

The terms “C₂-C₄-alkylene”, “C₁-C₆-alkylene” and “C₁-C₁₂-alkylene” denote straight or branded chain divalent hydrocarbon radicals containing two to four, one to six and one to twelve carbon atoms, respectively, which may optionally may be substituted with up to two groups selected from hydroxyl, halogen, aryl and C₁-C₆-alkanoyloxy.

The terms “C₃-C₈-cycloalkylene” and C₃-C₈-alkenylene” denote divalent saturated cyclic hydrocarbon radicals which contain three to eight carbon atoms and divalent hydrocarbon radicals which contain at least one carbon-carbon double bond and have three to eight carbon atoms, respectively.

The term “aryl” is used herein to denote phenyl and naphthyl optionally substituted with one or more groups selected from C₁-C₆-alkyl, C₁-C₆-alkoxy, halogen, carboxy, hydroxyl, C₁-C₆-alkoxycarbonyl, C₁-C₆-alkylsulfonyl, C₁-C₆-alkythio, thiocyano, cyano, nitro and trifluoromethyl.

In the term “heteroaryl” the heteroaryl groups or heteroaryl portions of the groups are mono or bicyclo heteroaromatic radicals containing at least one heteroatom selected from the group consisting of oxygen, sulfur and nitrogen or a combination of these atoms in combination with carbon to complete the heteroatomatic ring. Examples of suitable heteroaryl groups include but are not limited to: furyl, thienyl, thiazolyl, isothiazolyl, benzothiazolyl, pyrazolyl, pyrrolyl, thiadiazolyl, oxadiazolyl, benzoxazolyl, benzimidazolyl, pyridyl, pyrimidinyl and-triazolyl and such groups optionally substituted with one or more groups selected from C₁-C₆-alkyl, C₁-C₆-alkoxy, aryl, C₁-C₆-alkoxy, carbonyl, halogen, arylthio, arylsulfonyl, C₁-C₆-alkylthio, C₁-C₆-alkylsulfonyl, cyano, trifluoromethyl, and nitro.

The term “arylene” is used to denote 1,2-; 1,3-; 1,4-phenylene, naphthyl and those radicals optionally substituted with one or more groups selected from C₁-C₆-alkyl, C₁-C₆-alkoxy, halogen, carboxy, hydroxyl, C₁-C₆-alkoxycarbonyl, C₁-C₆-alkylsulfonyl, C₁-C₆-alkythio, thiocyano, cyano, nitro and trifluoromethyl.

The term “halogen” is used to denote fluorine, chlorine, bromine and iodine.

The alkoxylated moieties defined by the formulae: —(CHR₁₃CHR₁₄O)ₘ—R₁₅, and —(CHR₁₃CHR₁₄O)ₘ—CHR₁₃CHR₁₄—, have a chain length wherein m is from 1 to 500; preferably m is from 1 to about 100; more preferably m is from 1 to 8, and most preferably m is from 1 to 3. In a preferred embodiment, the alkoxylated moieties are ethylene oxide residues,.propylene oxide residues or residues of both.

The terms “pyrrolidino”, “piperidino”, “piperazino”, “morpholino”, “thiomorpholino” and “thiomorpholino-S,S-dioxide” are used herein to denote the following cyclic radicals, respectively: 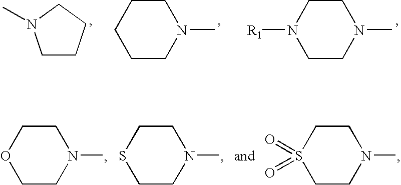
wherein R₁ is as defined above.

The skilled artisan will understand that each of the references herein to groups or moieties having a stated range of carbon atoms such as C₁-C₄-alkyl, C₁-C₆-alkyl, C₁-C₁₂-alkyl, C₃-C₈-cycloalkyl, C₃-C₈-alkenyl, C₁-C₁₂-alkylene, C₁-C₆-alkylene, includes moieties of all of the number of carbon atoms mentioned within the ranges. For example, the term “C₁-C₆-alkyl” includes not only the C₁ group (methyl) and C₆ group (hexyl) end points, but also each of the corresponding C₂, C₃, C₄, and C₅ groups including their isomers. In addition, it will be understood that each of the individual points within a stated range of carbon atoms may be further combined to describe subranges that are inherently within the stated overall range. For example, the term “C₃-C₈-cycloalkyl” includes not only the individual cyclic moieties C₃ through C₈, but also contemplates subranges such as C₄-C₆-cycloalkyl.

One skilled in the art will understand that various thermoplastic articles can be made where color is desired or excellent protection of the contents against UV and/or visible light would be important. Examples of such articles includes bottles, storage containers, sheets, films, fibers, plaques, hoses, tubes, syringes, and the like. Basically, the possible uses for polyester having a low-migratory light absorber is voluminous and cannot easily be enveloped.

The present invention is illustrated in greater detail by the prophetic example presented below. It is to be understood that this example is for illustrative purposes only and is not intended to be limiting of the invention.

### EXAMPLE 1

A light absorbing compound of Example 2 of U.S. Pat. No. 4,617,373 is prepared.

A polyester oligomer is prepared by mixing together in a stainless steel beaker the following: 651.35 g of purified terephthalic acid (3.92 moles); 13.29 g of purified isophthalic acid (0.08 moles); 397.25 g of virgin ethylene glycol (6.40 moles); and 0.23 g of antimony trioxide. The reactants are mixed using a 2-inch radius paddle stirrer connected to an electric motor to form a paste. After approximately ten minutes of stirring, the paste is aspirated into a stainless steel, 2-liter volume, pressure reactor. After the entire mixture is charged to the reactor, the reactor is purged three times by pressurizing with nitrogen then venting the nitrogen. During the initial pressurization, stirring is initiated using a 2-inch diameter anchor-style stirring element driven by a magnetic coupling to a motor. Stirring is increased until a final rate of 180 rpm, as measured by the shaft's rotation, is achieved.

After the pressure inside the reactor is 40 pounds per square inch (psi), the pressure is slowly vented to return the system to near atmospheric pressure while maintaining a slow nitrogen bleed through the reactor. After the final nitrogen purge, the pressure within the reactor is again increased to 40 psi.

Following the final pressurization step, the reactor's contents are heated to 245° C. over approximately 60 minutes using a resistance heating coil external to the reactor's contents. During the heat-up time, the reactor's pressure and stirring rate are maintained at 40 psi and 180 rpm, respectively.

After the target reaction temperature of 245° C. is achieved the reaction conditions are kept constant for the duration of the reaction sequence. The reaction time is 200 minutes, based upon an expected degree of completion of the esterification reactions. The by-product of the reaction is water. The actual extent of reaction is estimated by monitoring the mass of water collected over time. Water is removed from the vessel by distilling the water vapor from the reactor through a one inch diameter, 2.5 foot long, heated vertical column, fitted to the reactor's head. The column is packed with ¼″ diameter glass beads to facilitate the separation of the low boiling reaction by-products from free ethylene glycol and the esterification products. The column is connected by a horizontal section of pipe to a water cooled condenser. The lower end of the condenser is fitted with a pressure control valve that is positioned directly above a beaker resting on a balance. This arrangement allows the continuous removal of low-boiling reaction by-products from the reactor.

At the end of 200 minutes, the reactor pressure is reduced to atmospheric pressure over a twenty-five minute time period. The oligomer is collected in a stainless steel pan, allowed to cool and analyzed.

Analyses of the oligomer product is by using proton nuclear magnetic resonance spectroscopy (NMR) to determine the extent of reaction, the molar ratio of ethylene glycol to terephthalate and isophthalate moieties, the diethylene glycol content and the end group concentration.

The oligomer is allowed to harden, then pulverized and subsequently polymerized as described below.

Approximately 119 g of granulated oligomer product is placed into a 500 ml round-bottom flask. Two-grams of a mixture containing 2.00 g of light absorber compound in 100 g of ethylene glycol is added to the flask at the initiation of polymerization. This addition level theoretically will provide a concentration of 400 parts of absorbing compound to 1,000,000 parts of polymer.

A stainless steel paddle stirrer with a ¼ inch (0.635 cm) diameter shaft and a 2 inch (5.08 cm) diameter paddle is inserted into the round-bottom flask. An adapter fabricated with fittings for a nitrogen purge line, a vacuum line/condensate takeoff arm, a vacuum tight stirring shaft adapter, and a rubber septum for injection of additives, is inserted into the flask's 24/40 standard taper ground glass joint.

A nitrogen purge is initiated and the assembled apparatus is immersed into a pre-heated, molten metal bath whose temperature has equilibrated at 225° C. Once the flask's contents are melted, stirring is initiated. The conditions for the entire reaction process are summarized in table below.

TABLE I

| | Duration | Temp. | Pressure | Stirring Rate |
|---|---|---|---|---|
| Stage | (minutes) | (° C.) | (mm Hg) | (rpm of shaft) |
| 1 | 0.1 | 225 | Atmospheric | 25 |
| 2 | 5 | 225 | Atmospheric | 25 |
| 3 | 20 | 265 | Atmospheric | 50 |
| 4 | 5 | 265 | Atmospheric | 100 |
| 5 | 5 | 285 | Atmospheric | 100 |
| 6 | 1 | 285 | 200 | 100 |
| 7 | 1 | 285 | 0.8 | 100 |
| 8 | 75 | 285 | 0.8 | 75 |
| 9 | 1 | 285 | 150 | 0 |

Phosphorus is injected into the mixture at stage 6 as a solution of phosphoric acid in ethylene glycol. The target level of phosphorus is 20 ppm based on the theoretical yield of polyester. After completion of the reaction time indicated in Table I above, the metal bath is removed and the stirring is ceased. Within fifteen minutes the polymer mass is cooled sufficiently to solidify. The cooled solid is isolated from the flask and is ground in a Wiley hammer mill to produce a coarse powder having an average particle diameter of less than 3 mm. The powder is submitted for various tests such as solution viscosity, color, diethylene glycol content and ultraviolet absorber concentration.

The above reaction procedure typically produces a polyester suitable for having an intrinsic viscosity as measured at 25° C. in a mixture of 60% by weight phenol, 40% by weight 1,1,2,2-tetrachloroethanol, within the range of 0.60-0.72 dL/g.

Absorbance measurements produce a relationship between the concentration of light absorber compound and a solution's absorbance in accordance with Beer's law: A=abc (where A=absorbance, a=molar absorptivity, b=path length and c=concentration). Measurements are made using a 1 cm cell with a Perkin-Elmer Lambda 35 spectrophotometer. Absorbance is measured for all samples at 345 nm. Neat solvent mixture is used to blank the instrument prior to the evaluation of the light absorber containing samples. The concentration of the light absorber compound is determined by extrapolation of the test sample's absorbance to the linear fit of the absorbance vs. concentration data generated for the standard series.

Having described the invention in detail, those skilled in the art will appreciate that modifications may be made to the various aspects of the invention without departing from the scope and spirit of the invention disclosed and described herein. It is, therefore, not intended that the scope of the invention be limited to the specific embodiments illustrated and described but rather it is intended that the scope of the present invention be determined by the appended claims and their equivalents. Moreover, all patents, patent applications, publications, and literature references presented herein are incorporated by reference in their entirety for any disclosure pertinent to the practice of this invention.

1. A method for incorporating a light absorbing compound into a polyester prepared using direct esterification of reactants comprising a dicarboxylic acid and a diol, said method comprising:
a. combining said reactants in an esterifying reactor under conditions sufficient to form an esterified product comprising at least one of: an ester, an oligomer, a low molecular weight polyester and mixtures thereof;
b. polymerizing the esterified product in a polycondensation reactor to form a polyester; and
c. adding at least one UV absorbing compound to at least one of said esterification reactor or polycondensation reactor when at least 50% of the carboxy groups initially present in the reactants have been esterified, wherein said light absorbing compound is selected from the group consisting of compounds having have the formulae: 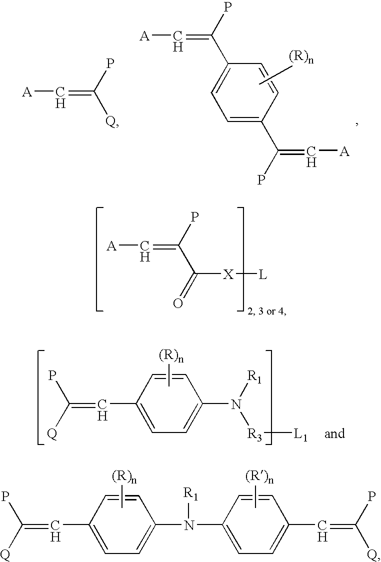
wherein:
A is conjugated with the attached double bond and is selected from the group consisting of nitrogen containing moieties having the following formulae: 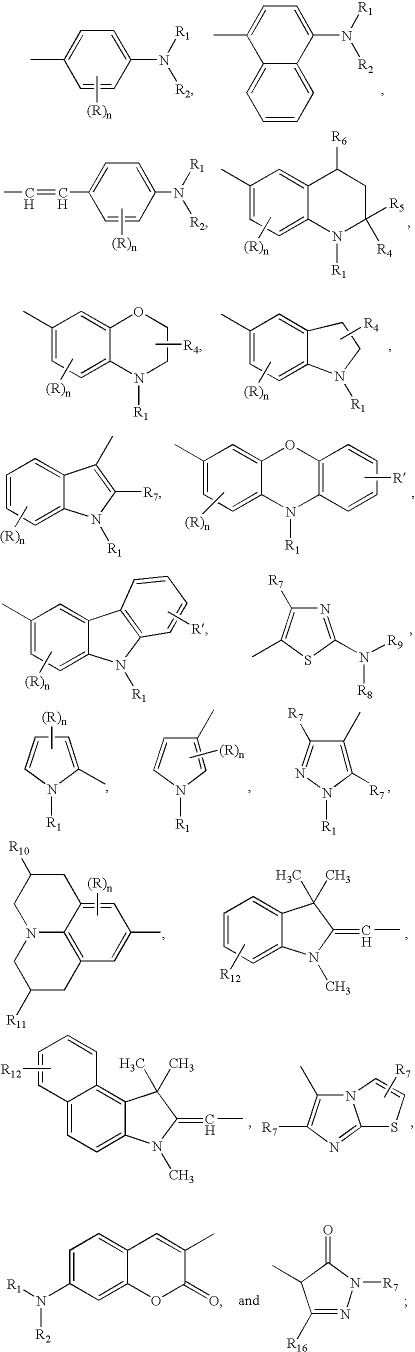
R and R′ are independently selected from the group consisting of hydrogen, C₁-C₆-alkyl, C₁-C₆-alkoxy and halogen;
n is 1 or 2;
R₁ is selected from the group consisting of C₃-C₈-cycloalkyl, C₃-C₈-alkenyl, aryl, C₁-C₁₂-alkyl, substituted C₁-C₁₂-alkyl, and —(CHR₁₃ CHR₁₄O)ₘ—R₁₅, wherein m is an integer from 1 to about 500; and
R₂ is selected from the group consisting of C₃-C₈-cycloalkyl, C₃-C₈-alkenyl, aryl, C₁-C₁₂-alkyl, substituted C₁-C₁₂-alkyl, —(CHR₁₃CHR₁₄O)ₘ—R₁₅, wherein m is an integer from 1 to about 500, and an acyl group selected from —COR₁₆, —CO₂R₁₆, —CONHR₁₆— and —SO₂R₁₆, with the provision that when R₂ is an acyl group R₁ may be hydrogen; or
R₁ and R₂ can be combined with the nitrogen atom to which they are attached to make cyclic structures selected from the group consisting of pyrrolidino, piperidino, piperazino, morpholino,, thiomorphol, thiomorpholino-S,S-dioxide, succinimido, and phthalimido;
R₃ is selected from the group consisting of C₁-C₆-alkylene, and —(CHR₁₃CHR₁₄O)ₘ—CHR₁₃CHR₁₄—, wherein m is an integer from 1 to about 500;
R₄, R₅ and R₆ are independently selected from the group consisting of hydrogen and C₁-C₆-alkyl;
R₇ is selected from the group consisting of hydrogen, C₁-C₆-alkyl and aryl;
R₈ and R₉ are independently selected from the group consisting of C₁-C₁₂-alkyl, substituted C₁-C₁₂-alkyl, aryl, C₃-C₈-cycloalkyl, and C₃-C₈-alkenyl; or
R₈ and R₉ can be combined with the nitrogen atom to which they are attached to produce cyclic structures selected from the group consisting of pyrrolidino, piperidino and morpholino;
R₁₀ and R₁₁ are independently selected from the group consisting of hydrogen, halogen, C₁-C₆-alkyl, hydroxyl and C₁-C₆-alkanoyloxy;
R₁₂ is selected from the group consisting of carboxy, C₁-C₆-alkoxycarbonyl and (R)ₙ;
R₁₃ and R₁₄ are independently selected from the group consisting of hydrogen and C₁-C₆-alkyl;
R₁₅ is selected from the group consisting of hydrogen, aryl, C₁-C₁₂-alkyl, and C₁-C₆-alkanoyloxy;
R₁₆ is selected from the group consisting of C₁-C₆-alkyl, C₃-C₈-alkenyl, aryl, and C₃-C₈-cycloalkyl;
X is selected from the group consisting of —O—, —NH and —N(R₁₆)—;
L is a di, tri or tetravalent linking group;
L₁ is selected from the group consisting of a direct single bond or a divalent linking group;
P and Q are independently selected from the group consisting of cyano, —COR₁₆, —CO₂R₁₆, —CON(R₁₇)R₁₈, aryl, heteroaryl, and —SO₂R₁₆; or
P and Q can be combined with the conjugated double-bonded carbon atom to which they are attached to produce divalent radicals selected from the group consisting of the following formulae: 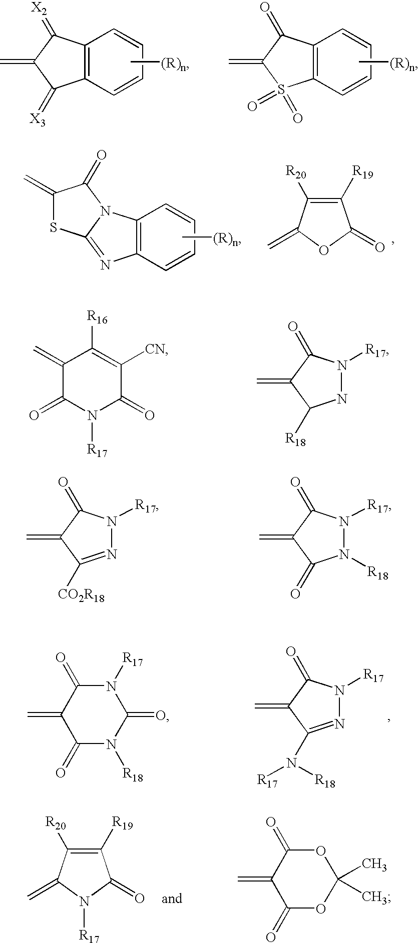
wherein:
R₁₇ and R₁₈ are independently selected from the group consisting of hydrogen, C₁-C₆-alkyl, aryl C₃-C₈-cycloalkyl, and C₃-C₈-alkenyl;
R₁₉ is selected from the group consisting of cyano, carboxy, —CO₂R₁₆, —CON(R₁₇)R₁₈ and 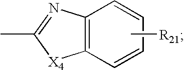
R₂₀ is selected from the group consisting of aryl and heteroaryl;
X₂ and X₃ are independently selected from the group consisting of oxygen and ═C(CN)CN;
X₄ is selected from the group consisting of —O—, —S—, —N(R₁₇)—;
R₂₁ is selected from the group consisting of hydrogen and up to two groups selected from C₁-C₆-alkyl, C₁-C₆-alkoxy, halogen, carboxy, cyano and —CO₂R₁₆, with the provision that Q may be hydrogen when P is selected from the group consisting of -carboxy, —CO₂R₁₆, —C(R₂₀)═C(CN)CN and 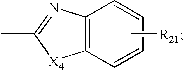
and wherein the light absorbing compound includes a polyester reactive group.

2. The method of claim 1 wherein said dicarboxylic acid is selected from the group consisting of aliphatic, alicyclic, or aromatic dicarboxylic acids.

3. The method of claim 2 wherein said dicarboxylic acid is selected from the group consisting of terephthalic acid; naphthalene dicarboxylic acid; isophthalic acid; 1,4-cyclohexanedicarboxylic acid; 1,3-cyclohexanedicarboxylic acid; succinic acid; glutaric acid; adipic acid; sebacic acid; and 1,12-dodecanedioic acid.

4. The method of claim 1 wherein said diol is selected from the group consisting of ethylene glycol; 1,4-cyclohexanedimethanol; 1,2-propanediol; 1,3-propanediol; 1,4-butanediol; 2,2-dimethyl-1,3-propanediol; 1,6-hexanediol; 1,2-cyclohexanediol; 1,4-cyclohexanediol; 1,2-cyclohexanedimethanol; 1,3-cyclohexanedimethanol; 2,2,4,4-tetramethyl-1,3-cyclobutane diol; X,8-bis(hydroxymethyl)tricyclo-[5.2.1.0]-decane wherein X represents 3, 4, or 5; diethylene glycol, triethylene glycol, dipropylene glycol, tripropylene glycol; diols containing from about 2 to about 18 carbon atoms in each aliphatic moiety and mixtures thereof.

5. The method of claim 1 wherein said polyester comprises greater than 50 mole % terephthalic acid residues and greater than 50 mole % ethylene glycol residues, wherein the acid component has 100 mole % and the diol component has 100 mole %.

6. The method of claim 1 wherein said polyester comprises greater than 75 mole % terephthalic acid residues and greater than 75 mole % ethylene glycol residues, wherein the acid component has 100 mole % and the diol component has 100 mole %.

7. The method of claim 1 wherein said light absorbing compound is added to at least one of said reactors when at least about 70% of the carboxy groups initially present in the reactants have been esterified.

8. The method of claim 1 wherein said UV absorbing compound is added to at least one of said reactors when at least about 80% of the carboxy groups initially present in the reactants have been esterified.

9. The method of claim 1 wherein said UV absorbing compound is added to at least one of said reactors when at least about 85% of the carboxy groups initially present in the reactants have been esterified.

10. The method of claim 1 wherein said UV absorbing compound is added to at least one of said reactors when greater than about 90% of the carboxy groups initially present in the reactants have been esterified.

11. The method of any one of claims 1 and 7-10 wherein from 0-100% of said light absorbing compound is added to the esterification reactor.

12. The method of claim 11 wherein less than 80% of said light absorbing compound is added in the esterification reactor.

13. The method of claim 11 wherein less than 50% of said light absorbing compound is added to the esterification reactor.

14. The method of any one of claims 1 and 7-10 wherein from 0-100% of said light absorbing compound is added to the polycondensation reactor.

15. The method of claim 14 wherein greater than 50% of said light absorbing compound is added to the polycondensation reactor.

16. The method of claim 14 wherein greater than 80% of said light absorbing compound is added to the polycondensation reactor.

17. The method of claim 14 wherein greater than 95% of said light absorbing compound is added to the polycondensation reactor.

18. The method of claim 1 wherein R₁ and R₂ combine to make cyclic structures selected from the group consisting of pyrrolidino, piperidino, piperazino, morpholino, thiomorpholino, thiomorpholino-S,S-dioxide, succinimido, and phthalimido.

19. The method of claim 1 wherein R₈ and R₉ are combined to produce cyclic structures selected from the group consisting of pyrrolidino, piperidino and morpholino.

20. The method of claim 1 wherein P and Q are independently selected from the group consisting of cyano, —COR₁₆, —CO₂R₁₆, —CON(R₁₇)R₁₈, aryl, heteroaryl, and —SO₂R₁₆.

21. The method of claim 1 wherein P and Q combine with the conjugated double-bonded carbon atom to which they are attached to produce cyclic divalent radicals selected from the group consisting of the following formulae:

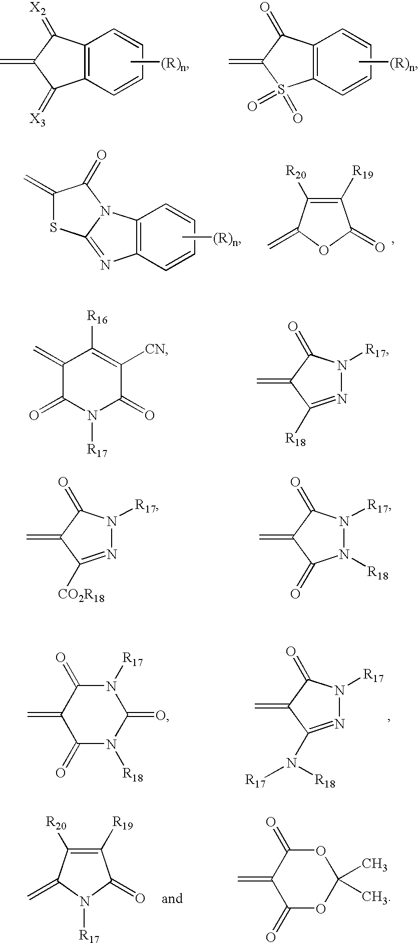

22. The method of claim 1 wherein said alkoxylated moiety represented by the formula —(CHR′CHR″O—)ₘ is selected from the group consisting of ethylene oxide residues, propylene oxide residues, or residues of both, and m is less than about 50.

23. The method of claim 22 wherein m is less than 8.

24. The method of claim 22 wherein m is from 1-3.

25. A method for incorporating a light absorbing compound into a polyester prepared using direct esterification of reactants which include a dicarboxylic acid and a diol, said method comprising:
a. combining said reactants in an esterifying reactor under conditions sufficient to form an esterified product comprising at least one of: an ester, an oligomer, a low molecular weight polyester and mixtures thereof;
b. polymerizing the esterified product in a polycondensation reactor to form a polyester; and
c. adding at least one UV absorbing compound to at least one of said esterification reactor or polycondensation reactor when at least 70% of the carboxy groups initially present in the reactants have been esterified, wherein said light absorbing compound is selected from the group consisting of compounds having have the formulae: 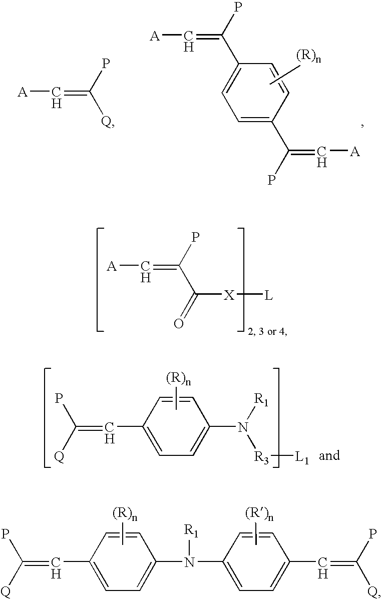
wherein:
A is conjugated with the attached double bond and is selected from the group consisting of nitrogen containing moieties having the following formulae: 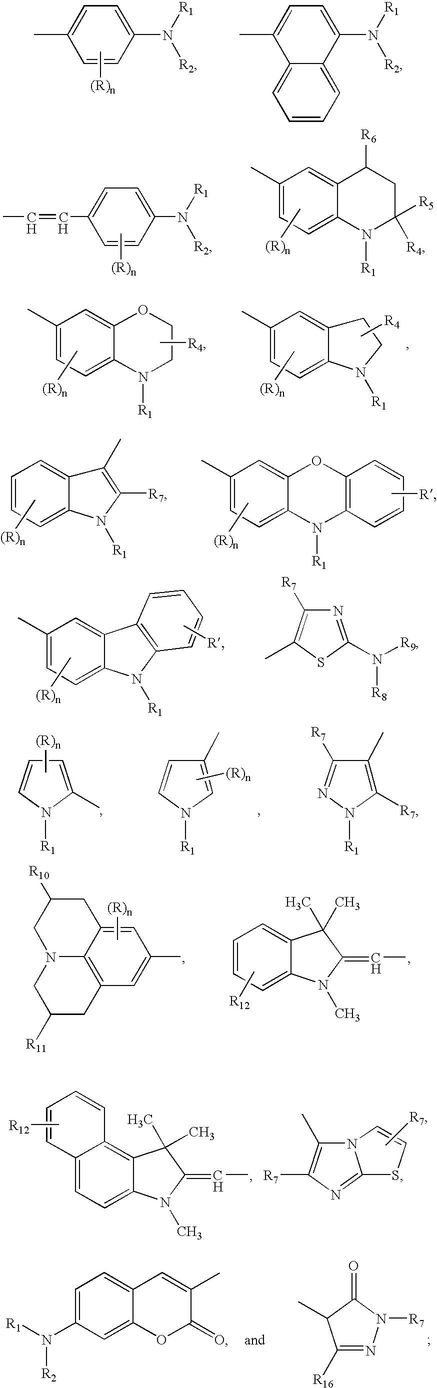
R and R′ are independently selected from the group consisting of hydrogen, C₁-C₆-alkyl, C₁-C₆-alkoxy and halogen;
n is 1 or 2;
R₁ is selected from the group consisting of C₃-C₈-cycloalkyl, C₃-C₈-alkenyl, aryl, C₁-C₁₂-alkyl, substituted C₁-C₁₂-alkyl, and —(CHR₁₃CHR₁₄O)ₘ—R₁₅, wherein m is an integer from 1 to about 100; and
R₂ is selected from the group consisting of C₃-C₈-cycloalkyl, C₃-C₈-alkenyl, aryl, C₁-C₁₂-alkyl, substituted C₁-C₁₂-alkyl, —(CHR₁₃ CHR₁₄O)ₘ—R₁₅, wherein m is an integer from 1 to about 100, and an acyl group selected from —COR₁₆, —CO₂R₁₆, —CONHR₁₆— and —SO₂R₁₆, with the provision that when R₂ is an acyl group R₁ may be hydrogen; or
R₁ and R₂ can be combined with the nitrogen atom to which they are attached to make cyclic structures selected from the group consisting of pyrrolidino, piperidino, piperazino, morpholino, thiomorpholino, thiomorpholino-S,S-dioxide, succinimido, and phthalimido;
R₃ is selected from the group consisting of C₁-C₆-alkylene, and —(CHR₁₃CHR₁₄O)ₘ—CHR₁₃CHR₁₄—, wherein m is an integer from 1 to about 100;
R₄, R₅ and R₆ are independently selected from the group consisting of hydrogen and C₁-C₆-alkyl;
R₇ is selected from the group consisting of hydrogen, C₁-C₆-alkyl and aryl;
R₈ and R₉ are independently selected from the group consisting of C₁-C₁₂-alkyl, substituted C₁-C₁₂-alkyl, aryl, C₃-C₈-cycloalkyl, and C₃-C₈-alkenyl; or
R₈ and R₉ can be combined with the nitrogen atom to which they are attached to produce cyclic structures selected from the group consisting of pyrrolidino, piperidino and morpholino;
R₁₀ and R₁₁ are independently selected from the group consisting of hydrogen, halogen, C₁-C₆-akyl, hydroxyl and C₁-C₆-alkanoyloxy;
R₁₂ is selected from the group consisting of carboxy, C₁-C₆-alkoxycarbonyl and (R)ₙ;
R₁₃ and R₁₄ are independently selected from the group consisting of hydrogen and C₁-C₆-alkyl;
R₁₅ is selected from the group consisting of hydrogen, aryl, C₁-C₁₂-alkyl, and C₁-C₆-alkanoyloxy;
R₁₆ is selected from the group consisting of C₁-C₆-alkyl, C₃-C₈-alkenyl, aryl, and C₃-C₈-cycloalkyl;
X is selected from the group consisting of —O—, —NH and —N(R₁₆)—;
L is a di, tri or tetravalent linking group;
L₁ is selected from the group consisting of a direct single bond or a divalent linking group;
P and Q are independently selected from the group consisting of cyano, —COR₁₆, —CO₂R₁₆, —CON(R₁₇)R₁₈, aryl, heteroaryl, and —SO₂R₁₆; or
P and Q can be combined with the conjugated double-bonded carbon atom to which they are attached to produce divalent radicals selected from the group consisting of the following formulae: 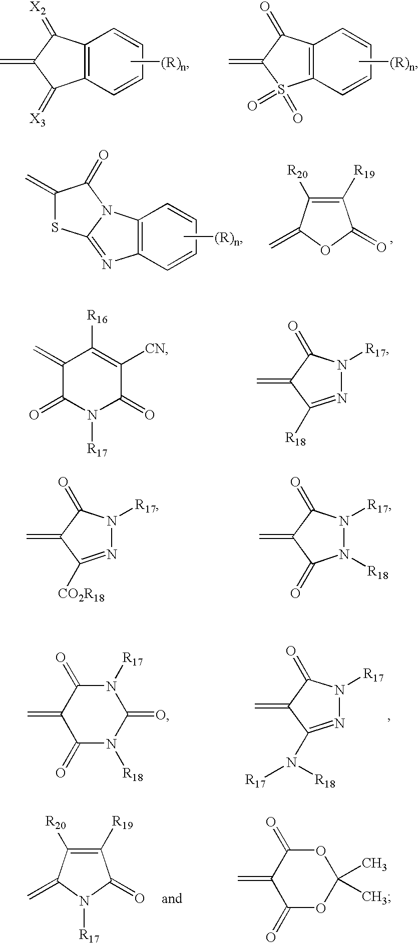
wherein:
R₁₇ and R₁₈ are independently selected from the group consisting of hydrogen, C₁-C₆-alkyl, aryl C₃-C₈-cycloalkyl, and C₃-C₈-alkenyl;
R₁₉ is selected from the group consisting of cyano, carboxy, —CO₂R₁₆, —CON(R₁₇)R₁₈ and 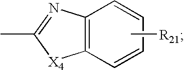
R₂₀ is selected from the group consisting of aryl and heteroaryl;
X₂ and X₃ are independently selected from the group consisting of oxygen and ═C(CN)CN;
X₄ is selected from the group consisting of —O—, —S—, —N(R₁₇)—;
R₂₁ is selected from the group consisting of hydrogen and up to two groups selected from C₁-C₆-alkyl, C₁-C₆-alkoxy, halogen, carboxy, cyano and —CO₂R₁₆, with the provision that Q may be hydrogen when P is selected from the group consisting of -carboxy, —CO₂R₁₆, —C(R₂₀)═C(CN)CN and 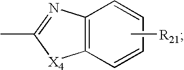
and wherein the light absorbing compound includes a polyester reactive group.

26. The method of claim 25 wherein said polyester comprises greater than 50 mole % terephthalic acid residues and greater than 50 mole % ethylene glycol residues, wherein the acid component has 100 mole % and the diol component has 100 mole %.

27. The method of claim 25 wherein said UV absorbing compound is added to at least one of said reactors when at least about 80% of the carboxy groups initially present in the reactants have been esterified.

28. The method of claim 25 wherein said UV absorbing compound is added to at least one of said reactors when greater than about 90% of the carboxy groups initially present in the reactants have been esterified.

29. The method of claim 25 wherein from 0-100% of said light absorbing compound is added to the esterification reactor.

30. The method of claim 25 wherein from 0-100% of said light absorbing compound is added to the polycondensation reactor.

31. The method of claim 25 wherein R₁ and R₂ combine to make cyclic structures selected from the group consisting of pyrrolidino, piperidino, piperazino, morpholino, thiomorpholino, thiomorpholino-S,S-dioxide, succinimido, and phthalimido.

32. The method of claim 25 wherein R₈ and R₉ combine to produce cyclic structures selected from the group consisting of pyrrolidino, piperidino and morpholino.

33. The method of claim 25 wherein P and Q are independently selected from the group consisting of cyano, —COR₁₆, —CO₂R₁₆, —CON(R₁₇)R₁₈, aryl, heteroaryl, and —SO₂R₁₆.

34. The method of claim 25 wherein P and Q are combined with the conjugated double-bonded carbon atom to which they are attached to produce cyclic divalent radicals selected from the group consisting of the following formulae:

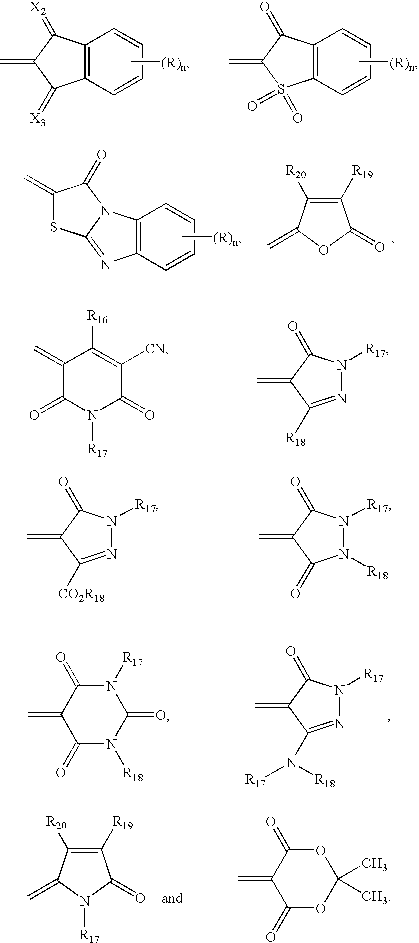

35. The method of claim 25 wherein said alkoxylated moiety represented by the formula —(CHR′CHR″O—)ₘ is selected from the group consisting of ethylene oxide residues, propylene oxide residues, or residues of both, and m is from 1 to 8.

36. The method of claim 25 wherein m is from 1-3.

37. A polyester prepared using direct esterification of reactants comprising a dicarboxylic acid and a diol, wherein a light absorbing compound is incorporated into the polyester by the method comprising:
a. combining said reactants in an esterifying reactor under conditions sufficient to form an esterified product comprising at least one of: an ester, an oligomer, a low molecular weight polyester and mixtures thereof;
b. polymerizing the esterified product in a polycondensation reactor to form a polyester; and
c. adding at least one UV absorbing compound to at least one of said esterification reactor or polycondensation reactor when at least 50% of the carboxy groups initially present in the reactants have been esterified, wherein said light absorbing compound is selected from the group consisting of compounds having have the formulae: 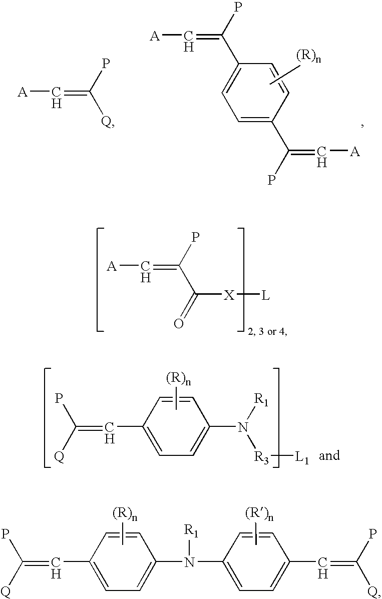
wherein:
A is conjugated with the attached double bond and is selected from the group consisting of nitrogen containing moieties having the following formulae: 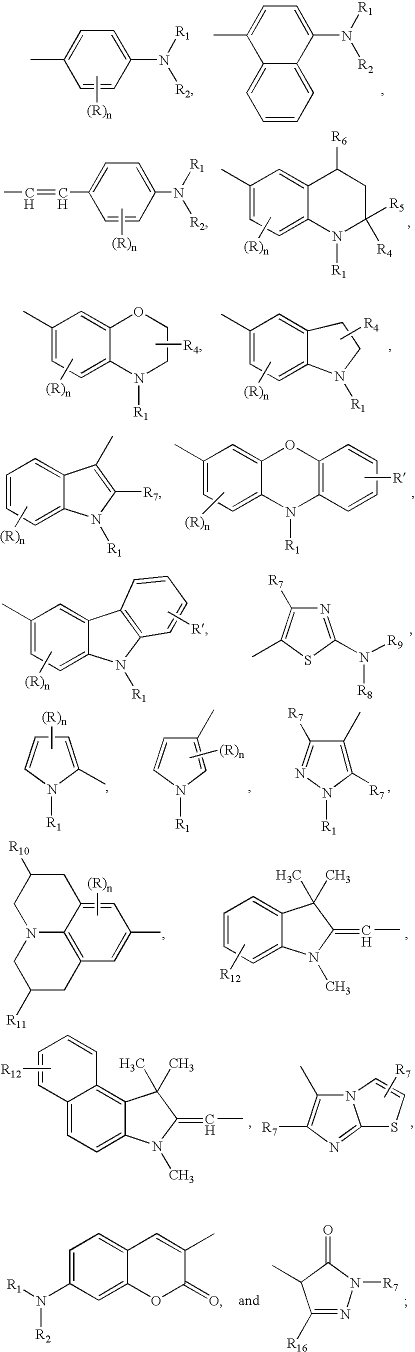
R and R′ are independently selected from the group consisting of hydrogen, C₁-C₆-alkyl, C₁-C₆-alkoxy and halogen;
n is 1 or 2;
R₁ is selected from the group consisting of C₃-C₈-cycloalkyl, C₃-C₈-alkenyl, aryl, C₁-C₁₂-alkyl, substituted C₁-C₁₂-alkyl, and —(CHR₁₃CHR₁₄O)ₘ—R₁₅, wherein m is an integer from 1 to about 500; and
R₂ is selected from the group consisting of C₃-C₈-cycloalkyl, C₃-C₈-alkenyl, aryl, C₁-C₁₂-alkyl, substituted C₁-C₁₂-alkyl, —(CHR₁₃CHR₁₄O)ₘ—R₁₅, wherein m is an integer from 1 to about 500, and an acyl group selected from —COR₁₆, —CO₂R₁₆, —CONHR₁₆— and —SO₂R₁₆, with the provision that when R₂ is an acyl group R₁ may be hydrogen;
R₃ is selected from the group consisting of C₁-C₆-alkylene, and —(CHR₁₃CHR₁₄O)ₘ—CHR₁₃CHR₁₄—, wherein m is an integer from 1 to about 500;
R₄, R₅ and R₆ are independently selected from the group consisting of hydrogen and C₁-C₆-alkyl;
R₇ is selected from the group consisting of hydrogen, C₁-C₆-alkyl and aryl;
R₈ and R₉ are independently selected from the group consisting of C₁-C₁₂-akyl, substituted C₁-C₁₂-alkyl, aryl, C₃-C₈-cycloalkyl, and C₃-C₈-alkenyl;
R₁₀ and R₁₁ are independently selected from the group consisting of hydrogen, halogen, C₁-C₆-akyl, hydroxyl and C₁-C₆-alkanoyloxy;
R₁₂ is selected from the group consisting of carboxy, C₁-C₆-alkoxycarbonyl and (R)ₙ;
R₁₃ and R₁₄ are independently selected from the group consisting of hydrogen and C₁-C₆-alkyl;
R₁₅ is selected from the group consisting of hydrogen, aryl, C₁-C₁₂-alkyl, and C₁-C₆-alkanoyloxy;
R₁₆ is selected from the group consisting of C₁-C₆-alkyl, C₃-C₈-alkenyl, aryl, and C₃-C₈-cycloalkyl;
X is selected from the group consisting of —O—, —NH and —N(R₁₆)—;
L is a di, tri or tetravalent linking group;
L₁ is selected from the group consisting of a direct single bond or a divalent linking group;
P and Q are indepenently selected from the group consisting of cyano, —COR₁₆, —CO₂R₁₆, —CON(R₁₇)R₁₈, aryl, heteroaryl, and —SO₂R₁₆; or
P and Q are combined with the conjugated double-bonded carbon atom to which they are attached to produce divalent radicals selected from the group consisting of the following formulae: 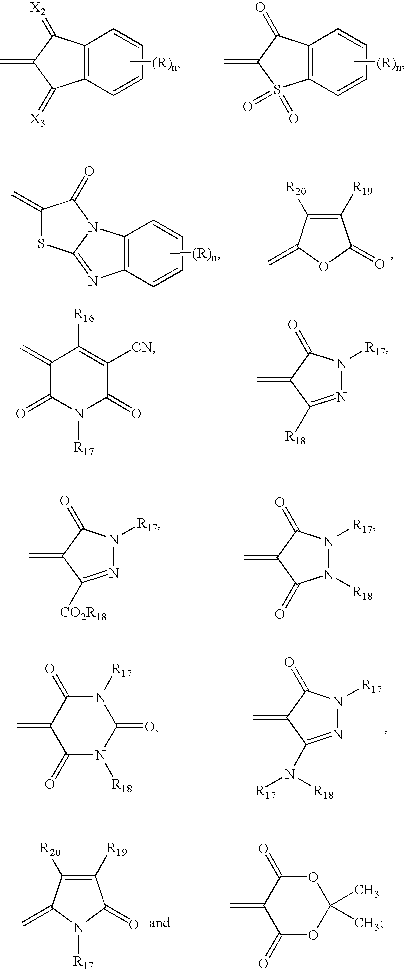
wherein
R₁₇ and R₁₈ are independently selected from the group consisting of hydrogen, C₁-C₆-alkyl, aryl C₃-C₈-cycloalkyl, and C₃-C₈-alkenyl;
R₁₉ is selected from the group consisting of cyano, carboxy, —CO₂R₁₆, —CON(R₁₇)R₁₈ and 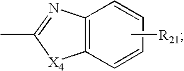
R₂₀ is selected from the group consisting of aryl and heteroaryl;
X₂ and X₃ are independently selected from the group consisting of oxygen and ═C(CN)CN;
X₄ is selected from the group consisting of —O—, —S—, —N(R₁₇)—;
R₂₁ is selected from the group consisting of hydrogen and up to two groups selected from C₁-C₆-alkyl, C₁-C₆-alkoxy, halogen, carboxy, cyano and —CO₂R₁₆, with the provision that Q may be hydrogen when P is selected from the group consisting of -carboxy, —CO₂R₁₆, —C(R₂₀)═C(CN)CN and 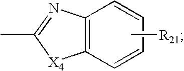
and wherein the light absorbing compound includes a polyester reactive group.

38. The polyester of claim 37 further comprising R₁ and R₂ are combined with the nitrogen atom to which they are attached to make cyclic structures selected from the group consisting of pyrrolidino, piperidino, piperazino, morpholino, thiomorpholino, thiomorpholino-S,S-dioxide, succinimido, and phthalimido.

39. The polyester of claim 37 further comprising R₈ and R₉ are combined with the nitrogen atom to which they are attached to produce cyclic structures selected from the group consisting of pyrrolidino, piperidino and morpholino.

40. The polyester of claim 37 wherein said alkoxylated moiety represented by the formula —(CHR′CHR″O—)ₘ is selected from the group consisting of ethylene oxide residues, propylene oxide residues, or residues of both, and m is from 1 to 8.

41. The polyester of claim 37 wherein m is from 1-3.

42. A thermoplastic article prepared using the polyester of claim 37.

43. The thermoplastic article of claim 42 wherein said article is selected from the group consisting of bottles, storage containers, sheets, films, plaques, hoses, tubes, and syringes.
